(19) United States
(12) Patent Application Publication
(10) Pub. No.: US 2006/0047601 A1
(43) Pub. Date: Mar. 2, 2006

(54) Method and apparatus for providing channel key data

(75) Inventors: Petr Peterka, San Diego, CA (US); Geetha Mangalore, San Diego, CA (US); Alexander Medvinsky, San Diego, CA (US); Paul Moroney, Olivenhain, CA (US); Rafie Shamsaasef, San Diego, CA (US)

Correspondence Address: GENERAL INSTRUMENT CORPORATION DBA THE CONNECTED;HOME SOLUTIONS BUSINESS OF MOTOROLA, INC., 101 TOURNAMENT DRIVE, HORSHAM, PA, 19044, US

(73) Assignee: General Instrument Corporation

(21) Appl. No.: 11/180,151

(22) Filed: Jul. 13, 2005

Related U.S. Application Data
(60) Provisional application No. 60/604,343, filed on Aug. 25, 2004.

(51) Int. Cl. G06Q 99/00; H04L 9/00; H04K 1/00

(52) U.S. Cl. 705/51

(57) ABSTRACT

The present invention discloses an apparatus and method for distributing channel key data to an endpoint device. In one example, the present invention provides channel key data to at least one endpoint device prior to the endpoint device being tuned to at least one channel associated with the channel key data. The endpoint device is then informed of the expiration time of the channel key data and is subsequently, upon request, provided the replacement channel key data on a optimized basis (e.g. randomized or utilizing some other optimization algorithm) prior to the expiration time of the original channel key data.

### CROSS-REFERENCE TO RELATED APPLICATIONS

This application claims benefit of U.S. provisional patent application Ser. No. 60/604,343, filed Aug. 25, 2004, which is herein incorporated by reference.

### BACKGROUND OF THE INVENTION

1. Field of the Invention

Embodiments of the present invention generally relate to video-over-networks, e.g., video-over-IP networks. More specifically, the present invention relates to a method and apparatus for securely providing channel key data in a multicast video-over-IP network.

2. Description of the Related Art

Digital contents have gained wide acceptance in the public. Such contents include, but are not limited to: movies, videos, music and the like. Consequently, many consumers and businesses employ various digital media devices or systems that enable the reception of such digital multimedia contents via several different communication channels, e.g., a wireless link, such as a satellite link or a wired link such as a cable connection. Similarly, the communication channel may also be a telephony based connection, such as DSL and the like.

Regardless of the communication channels that are employed to receive the digital contents, owners of digital contents as well as the service providers (e.g., a cable service provider, a telecommunication service provider, a satellite-based service provider, merchants, and the like) who provide such digital contents to users typically deliver a global key to subscribers when the security of the system is provided by hardware components. However, several content owners opt to implement software security measures in order to reduce costs. Consequently, the provision of global keys is replaced with the practice of providing authorized channel keys to select subscribers. Unfortunately, this solution challenges the scalability aspects of this system. Such problems may lead to end-users experiencing delays in the tuning response time when channels are changed.

Thus, there is a need in the art for a method and apparatus for providing channel key data more efficiently and with minimal delay.

### SUMMARY OF THE INVENTION

In one embodiment, the present invention discloses an apparatus and method for distributing channel key data to an endpoint device. Notably, the present invention provides channel key data to at least one endpoint device prior to the endpoint device(s) being tuned to at least one channel associated with the channel key data. The endpoint device is then informed of the expiration time of the channel key data and is subsequently, upon request, provided the replacement channel key data on a optimized basis (e.g. randomized or utilizing some other optimization algorithm) prior to the expiration time of the original channel key data.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts a block diagram of a system for distributing channel key data in accordance with the present invention;

FIG. 2 depicts a method for distributing channel key data in accordance with the present invention; and

FIG. 3 is a block diagram depicting an exemplary embodiment of a computer suitable for implementing the processes and methods described herein.

To facilitate understanding, identical reference numerals have been used, wherever possible, to designate identical elements that are common to the figures.

### DETAILED DESCRIPTION

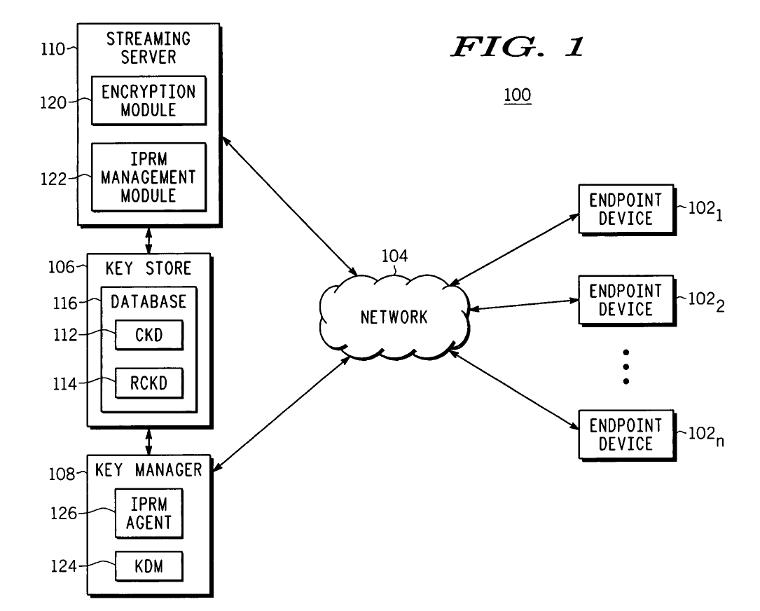

FIG. 1 illustrates a content distribution system 100 of the present invention. The content distribution system 100 may be a multicast video-over-IP network utilizing a Digital Rights Management (DRM) system, such as an Internet Protocol Rights Management (IPRM) system and the like. In one embodiment, the content distribution system 100 comprises a plurality of endpoint devices 102_{1 . . . n} that are coupled to a conventional data communications network 104 (e.g., the Internet, LAN, WAN, and the like). The endpoint devices 102 may include a set top box, a media center, a personal video recorder, a home gateway, a computer, and a cellular phone, and the like. Also connected to the communications network 104 are a streaming server 110 and a Key Manager 108 (which are similarly connected to each other). For the sake of simplicity, only one streaming server 110 and one Key Manager 108 are shown. Those skilled in the art will understand that a plurality of streaming servers or Key Managers may be connected to the communications network 104 and to one another to form a larger system. The Key Manager 108 and streaming server 110 are also directly coupled to at least one Key Store 106.

The streaming server 110 comprises a stand alone server that is responsible for providing content to the endpoint devices 102_{1 . . . n}. In order to securely stream content between the server 110 and an endpoint device 102, a secure session must initially be established by either the server 110 or the device 102. In order to provide content to a plurality of endpoint devices, the streaming server 110 may initiate a multicast distribution session. Multicasting is the transmission or distribution of a single message (e.g., digital content) to a select group of recipients. During the multicast distribution of content, set top boxes or users do not typically initiate the streaming session, but instead join a session that is already in progress. In this scenario, the streaming server 110 generates the channel key data at the beginning of the multicast session or alternatively, sometime prior to the endpoint devices 102_{1 . . . n} joining the session. Specifically, the streaming server 110 initially generates the channel key data 112 and then provides it to the Key Store 106 for storage. Once the Key Store 106 possesses the channel key data 112, it may subsequently be obtained by the Key Manager 108 (which ultimately provides the data to the endpoint devices 102_{1 . . . n}). Notably, the provisioning of the channel key data 112 in advance is intended to minimize the channel acquisition time during a rapid channel change (e.g., “channel surfing”). The streaming server 110 also contains an encryption module 120 and an IPRM management module 122. The encryption module 120 initiates secure session for streaming and establishing channel key data with the Key Store 106. In one embodiment, the encryption module 120 generates the channel key data to be stored in the Key Store 106. The IPRM management module 122 may be a software component responsible for establishing a secure session with the Key Store 106. The management module 122 may also monitor all of the aspects pertaining to authentication and the communication between the different servers (e.g., the streaming server 110, Key Manager 108, etc.). In one embodiment, the IPRM management module 122 comprises an ESBroker key management protocol software module.

The Key Store 106 may be a stand alone secure database server for storing channel key data 112. In one embodiment, communication between then encryption module 120 and the Key Manager 108 is facilitated by the Key Store 106. More specifically, the Key Store 106 is used to store channel key data originating from the streaming server 110 and intended for the Key Manager 108. In one embodiment, the channel key data 112 comprises content subkeys (or key seeds) that are used by the end-point devices 102 to derive the content decryption key. This may also be combined with a mechanism where the content keys change much more frequently than the subkeys. In that case, the content key changes are signaled in the actual content or in a set of separate messages (e.g., Entitlement Control Messages or ECMs). In another embodiment, the Key Store 106 persistently stores channel key data 112 in a database 116. Channel key data 112 for each channel is generated and stored in the Key Store 106 when requested by the encryption module 110 via the IPRM management module 122, and is identified by a secure session identifier (SSID). Namely, the SSID associates the channel key data with a corresponding channel or a group of channels that are protected using the same set of channel key data. The channel key data 112 is also stored in a secure format within the database 116, e.g., the keys are encrypted and the database records are authenticated. The channel key data 112 stored in the Key Store may be used by a Key Manager 108 as well as the encryption module 120 in the event the streaming server 110 is restarted. Similarly, the Key Store 106 stores replacement channel key data 114 in the database 116. In one embodiment, the replacement channel key data 114 are the channel keys that ultimately replace the original channel key data 112 presently being utilized by the endpoint device 102 upon the expiration of the original data. The channel key data 112 may be configured to expire after any predetermined amount of time. In one embodiment, the channel key data 112 is frequently replaced in the interest of security.

The Key Manager 108 may also comprise a stand alone server computer that assists individual endpoint devices (e.g., set top boxes) request channel key data for separate channels. In one embodiment, the Key Manager 108 requests channel key data 112 for all existing channels from a Key Store 106 at one time. Specifically, the Key Manager 108 caches channel key data in order to minimize the number of transactions to the Key Store 106. Thus, by caching the data, the Key Manager 108 eliminates the need for obtaining the data for subsequent user requests for the same channel or content. Once provisioned with this data, the Key Manager 108 is able to distribute the channel key data to all the endpoint devices 102_{1 . . . n} automatically or upon request. The Key Manager contains two modules, the IPRM Management module 126 (which is similar to IPRM 122) and the key distribution module 124. The IPRM Management Module 126 is responsible for providing application-level functions and can integrate with higher-level applications, such as the KDM module 124. The key distribution module 124 is the component that enables the Key Manager to provide channel key data to endpoint devices. In one embodiment, the number of Key Managers in the network exceeds the number of streaming servers (and the respective encryption modules). By employing a large number of Key Managers to accommodate numerous endpoint devices 102_{1 . . . n}, the scalability concerns of the system may be addressed. Notably, there may only be a single multicast stream that is encrypted and sent out by a streaming server 110. However there could be millions of endpoint devices tuned into a live event. A single streaming server would not be able to scale to such numbers. As a result, there is a need for a plurality of Key Managers in order to provide the requisite channel key data. Thus, this particular network configuration allows a large population of clients to be supported (i.e., as the number of endpoint devices increase, a number of Key Managers may be added in order to accommodate the potential proliferation of endpoint devices).

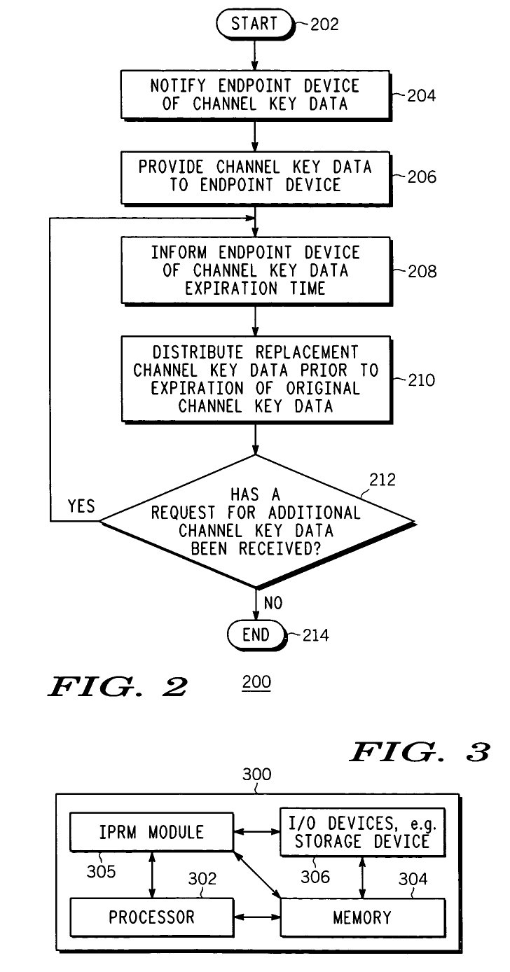

FIG. 2 illustrates a method 200 for distributing channel key data to an endpoint device in accordance with the present invention. Method 200 begins at step 202 and proceeds to step 204 where at least one endpoint device 102 is notified of requisite channel key data. In one embodiment of the present invention, the endpoint devices 102_{1 . . . n} are notified as to what channel key data (e.g., channel keys) is required for each channel by “listening” to Service Annoucement Protocol/Session Description Protocol (SAP/SDP) messages. Alternatively, this information may be obtained from an Electronic Program Guide (EPG) portal by an endpoint device 102. By obtaining this information ahead of time, an endpoint device 102 is able to “prefetch” the channel keys before a user tunes to a given channel. Thus, the lag exhibited by selecting a channel without the possession of the requisite channel key data may be avoided (i.e., the time expended to obtain the necessary channel key after the user tunes to a given channel).

At step 206, the channel key data is provided to at least one endpoint device. In one embodiment, the requisite channel key data is transmitted directly to the endpoint device from the Key Manager 108 (previously obtained from the Key Store 106) automatically. In another embodiment, the endpoint device requests the channel key data from the Key Manager 108. IN order to efficiently manage all of the requests from the plurality of endpoint devices, the request for the channel key data may be made by an endpoint device on a random basis or in accordance with an optimization algorithm. The Key Manager 108 subsequently provides the requested channel keys to the appropriate endpoint device. In one embodiment, the endpoint device 102 stores the requested channel key data in a cache until the channel keys expire. Endpoint devices 102_{1 . . . n} may store channel key data persistently in order to facilitate fast channel tuning after the device is turned of and back on. This may be useful after a power outage where a large number of devices may request channel key data at the same time.

At step 208, the endpoint device 102 is informed of the channel key data expiration time. In order to improve the security of the system, channel keys are periodically changed because they are configured to expire (e.g., become invalid) after a set, predetermined amount of time. In one embodiment, the expiration of the channel key data is communicated to the endpoint device 102 by the streaming server 110 (or encryption module 120) via the Key Manager 108. Notably, the Key Manager 108 learns about the expiration time of a channel key at the instant the Key Manager 108 obtains this channel key data 112 from the Key Store 106. Although a Key Manager 108 typically obtains the channel keys before the endpoint devices 102_{1 . . . n} request the channel key data, the Key Manager 108 may request it from the Key Store 106 at that time in the event it does not have the requested data. In one embodiment, the Key Manager 108 obtains channel key data (e.g., replacement channel key data) from the Key Store 106 according to a caching optimization schedule.

At step 210, replacement channel key data is distributed to at least one endpoint device 102 prior to the expiration of the original channel key data. In one embodiment, the replacement channel key data is automatically distributed to the endpoint device from the Key Manager in a random manner. In another embodiment, in order to scale the system in such a way that prevents overloading the Key Managers, endpoint devices 102_{1 . . . n} are configured to fetch the replacement channel key data at random times. The random times may occur at any instance between the time the original key data becomes active and the time the current key data expires. In one embodiment, an endpoint device 102 is configured with an algorithm that enables the device to randomly issue channel key data requests to the Key Manager 108. For example, the algorithm in an endpoint device 102 selects a random time within the aforementioned time period and subsequently transmits a request to the Key Manager 108 at that designated “random” time. The Key Manager 108 then distributes the replacement channel key data to the endpoint device 102 upon receiving the request from the endpoint device 102.

At step 212, an inquiry is made as to whether a request for additional channel key data has been received. In one embodiment, the Key Manager awaits for the next request from at least one of the endpoint devices. The Key Manager typically remains on “standby” mode until a predetermined time period. After waiting for the specified amount of time without receiving any requests from at least one endpoint device, the Key Manager may shut down for a short period of time or until an endpoint device makes a subsequent request. In another embodiment, the method 200 ignores this step since the Key Manager is configured to automatically supply channel key data to the endpoint devices.

FIG. 3 depicts a high level block diagram of a general purpose computer suitable for use in performing the functions described herein. As depicted in FIG. 3, the system 300 comprises a processor element 302 (e.g., a CPU), a memory 304, e.g., random access memory (RAM) and/or read only memory (ROM) and/or persistent memory (Flash), an IPRM management module 305 (not named on the diagram) (i.e., the IPRM management module 122 in FIG. 1), and various input/output devices 306 (e.g., storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like)).

It should be noted that the present invention can be implemented in software and/or in a combination of software and hardware, e.g., using application specific integrated circuits (ASIC), a general purpose computer or any other hardware equivalents. In one embodiment, the IPRM management module or process 305 can be loaded into memory 304 and executed by processor 302 to implement the functions as discussed above. As such, the present IPRM management module 305 (including associated data structures) of the present invention can be stored on a computer readable medium or carrier, e.g., RAM memory, magnetic or optical drive or diskette and the like.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

While the foregoing is directed to embodiments of the present invention, other and further embodiments of the invention may be devised without departing from the basic scope thereof, and the scope thereof is determined by the claims that follow.

1. A method for distributing channel key data to at least one endpoint device, comprising:
providing said channel key data to said at least one endpoint device;
supplying said at least one endpoint device with an expiration time of said channel key data; and
distributing replacement channel key data to said at least one endpoint device prior to said expiration time of said channel key data.

2. The method of claim 1, wherein said at least one endpoint device comprises at least one of: a set top box, a media center, a personal video recorder, a home gateway, a computer, and a cellular phone.

3. The method of claim 1, wherein said distributing step comprises providing said replacement channel key data in response to a request randomly transmitted by said at least one endpoint device.

4. The method of claim 1, wherein at least one of said channel key data and said replacement channel key data is stored in a Key Store and is identified by a secure session identifier (SSID).

5. The method of claim 4, wherein said Key Store supports at least one of: a streaming server, an encryption module, and a Key Manager.

6. The method of claim 4, wherein at least one Key Manager makes a request for either of said channel key data or said replacement channel key data from said Key Store before either of said channel key data or said replacement channel key data is required by said at least one endpoint device.

7. The method of claim 6, wherein said at least one endpoint device requests said replacement channel key data on a random basis or in accordance to an optimization algorithm from said at least one Key Manager.

8. The method of claim 1, wherein said at least one endpoint device stores said channel key data persistently in order to facilitate fast channel tuning after said at least one endpoint device loses power and is subsequently supplied with power.

9. An apparatus for distributing channel key data to at least one endpoint device, comprising:
means for providing said channel key data to said at least one endpoint device;
means for supplying said at least one endpoint device with an expiration time of said channel key data; and
means for distributing replacement channel key data to said at least one endpoint device prior to said expiration time of said channel key data.

10. The apparatus of claim 9, wherein said at least one endpoint device comprises at least one of: a set top box, a media center, a personal video recorder, a home gateway, a computer, and a cellular phone.

11. The apparatus of claim 9, wherein said distributing means provides said replacement channel key data in response to a request randomly transmitted by said at least one endpoint device.

12. The apparatus of claim 9, wherein at least one of said channel key data and said replacement channel key data is stored in a Key Store and is identified by a secure session identifier (SSID).

13. The apparatus of claim 12, wherein said Key Store supports at least one of: a streaming server, an encryption module, and a Key Manager.

14. The apparatus of claim 12, wherein at least one Key Manager makes a request for either of said channel key data or said replacement channel key data from said Key Store before either of said channel key data or said replacement channel key data is required by said at least one endpoint device.

15. The apparatus of claim 14, wherein said at least one endpoint device requests said replacement channel key data on a random basis or in accordance to an optimization algorithm from said at least on Key Manager.

16. The apparatus of claim 9, wherein said at least one endpoint device stores said channel key data persistently in order to facilitate fast channel tuning after said at least one endpoint device loses power and is subsequently supplied with power.

17. An apparatus for receiving channel key data, comprising:
means for receiving said channel key data;
means for acquiring an expiration time of said channel key data; and
means for obtaining replacement channel key data prior to said expiration time of said channel key data.

18. The apparatus of claim 17, wherein said apparatus comprises at least one of: a set top box, a cable modem, a computer, and a cellular phone.

19. The apparatus of claim 17, wherein said means for obtaining receives said replacement channel key data in response to a request randomly transmitted by said apparatus.

20. The apparatus of claim 17, wherein said replacement channel key data is stored in a Key Store server and is identified by a secure session identifier (SSID).
